(19) United States
(12) Patent Application Publication
(10) Pub. No.: US 2010/0221603 A1
(43) Pub. Date: Sep. 2, 2010

(54) LITHIUM ION FLUORIDE BATTERY

(76) Inventors: Rachid YAZAMI, Los Angeles, CA (US); Isabelle M. DAROLLES, Los Angeles, CA (US); Cedric M. WEISS, Pasadena, CA (US)

Correspondence Address: GREENLEE WINNER AND SULLIVAN P C, 4875 PEARL EAST CIRCLE, SUITE 200, BOULDER, CO, 80301, US

(21) Appl. No.: 12/718,212

(22) Filed: Mar. 5, 2010

Related U.S. Application Data
(63) Continuation-in-part of application No. 11/681,493, filed on Mar. 2, 2007.
(60) Provisional application No. 61/209,512, filed on Mar. 6, 2009.
(60) Provisional application No. 60/779,054, filed on Mar. 3, 2006.
(60) Provisional application No. 60/897,310, filed on Jan. 25, 2007.
(60) Provisional application No. 60/900,409, filed on Feb. 9, 2007.

(51) Int. Cl. H01M 6/04; H02J 7/00

(52) U.S. Cl. 429/188; 320/127

(57) ABSTRACT

The present invention provides electrochemical cells capable of good electronic performance, particularly high specific energies, useful discharge rate capabilities and good cycle life. The invention includes primary and secondary batteries having positive and negative electrodes that exchange fluoride ions with an electrolyte comprising a fluoride salt and solvent.

### CROSS-REFERENCE TO RELATED APPLICATIONS

This application claims the benefit of U.S. Provisional Application No. 61/209,512, filed Mar. 6, 2009, which is incorporated by reference in its entirety with the present disclosure.

This application is a continuation-in-part of U.S. application Ser. No. 11/681,493, filed Mar. 2, 2007, which claims the benefit of priority of U.S. provisional Patent Application 60/779,054 filed Mar. 3, 2006, U.S. provisional Patent Application 60/897,310, filed Jan. 25, 2007, and U.S. provisional Patent Application 60/900,709, filed Feb. 9, 2007, and each of these applications are incorporated by reference in their entireties to the extent not inconsistent with the disclosure herein.

### STATEMENT REGARDING FEDERALLY SPONSORED RESEARCH OR DEVELOPMENT

Not applicable.

### BACKGROUND OF INVENTION

Over the last few decades revolutionary advances have been made in electrochemical storage and conversion devices expanding the capabilities of these systems in a variety of fields including portable electronic devices, air and space craft technologies, and biomedical instrumentation. Current state of the art electrochemical storage and conversion devices have designs and performance attributes that are specifically engineered to provide compatibility with a diverse range of application requirements and operating environments. For example, advanced electrochemical storage systems have been developed spanning the range from high energy density batteries exhibiting very low self discharge rates and high discharge reliability for implanted medical devices to inexpensive, light weight rechargeable batteries providing long runtimes for a wide range of portable electronic devices to high capacity batteries for military and aerospace applications capable of providing extremely high discharge rates over short time periods.

Despite the development and widespread adoption of this diverse suite of advanced electrochemical storage and conversion systems, significant pressure continues to stimulate research to expand the functionality of these systems to enable an even wider range of device applications. Large growth in the demand for high power portable electronic products, for example, has created enormous interest in developing safe, light weight primary and secondary batteries providing higher energy densities. In addition, the demand for miniaturization in the field of consumer electronics and instrumentation continues to stimulate research into novel design and material strategies for reducing the sizes, masses and form factors of high performance batteries. Further, continued development in the fields of electric vehicles and aerospace engineering has also created a need for mechanically robust, high reliability, high energy density and high power density batteries capable of good device performance in a useful range of operating environments.

State of the art lithium ion secondary batteries provide excellent charge-discharge characteristics, and thus, have been widely adopted as power sources in portable electronic devices, such as cellular telephones and portable computers. U.S. Pat. Nos. 6,852,446, 6,306,540, 6,489,055, and “Lithium Batteries Science and Technology” edited by Gholam-Abbas Nazri and Gianfranceo Pistoia, Kluer Academic Publishers, 2004, are directed to lithium and lithium ion battery systems which are hereby incorporated by reference in their entireties.

Dual-carbon cells have also been developed that utilize lithium insertion reactions for electrochemical storage, wherein anions and cations generated by dissolution of an appropriate electrolyte salt provide the source of charge stored in the electrodes. During charging of these systems, cations of the electrolyte, such as lithium ion (Li⁺), undergo insertion reaction at a negative electrode comprising a carbonaceous cation host material, and anions of the electrolyte, such as PF₆⁻, undergo insertion reaction at a positive electrode carbonaceous anion host material. During discharge, the insertion reactions are reversed resulting in release of cations and anions from positive and negative electrodes, respectively. State of the art dual-carbon cells are unable to provide energy densities as large as those provided by lithium ion cells, however, due to practical limitations on the salt concentrations obtainable in these systems. In addition, some dual-carbon cells are susceptible to significant losses in capacity after cycling due to stresses imparted by insertion and de-insertion of polyatomic anion charge carriers such as PF₆⁻. Further, dual-carbon cells are limited with respect to the discharge and charging rates attainable, and many of these system utilize electrolytes comprising lithium salts, which can raise safety issues under some operating conditions. Dual carbon cells are described in U.S. Pat. Nos. 4,830,938; 4,865,931; 5,518,836; and 5,532,083, and in “Energy and Capacity Projections for Practical Dual-Graphite Cells”, J. R. Dahn and J. A. Seel, Journal of the Electrochemical Society, 147 (3) 899-901 (2000), which are hereby incorporated by reference to the extent not inconsistent with the present disclosure.

A battery consists of a positive electrode (cathode during discharge), a negative electrode (anode during discharge) and an electrolyte. The electrolyte contains ionic species that are the charge carriers. Electrolytes in batteries can be of several different types: (1) pure cation conductors (e.g., beta Alumina conducts with Na⁺ only); (2) pure anion conductors (e.g., high temperature ceramics conduct with O⁻ or O²⁻ anions only); and (3) mixed ionic conductors: (e.g., some Alkaline batteries use a KOH aqueous solution that conducts with both OH⁻ and K⁺, whereas some lithium ion batteries use an organic solution of LiPF₆ that conducts with both Li⁺ and PF₆⁻). During charge and discharge, electrodes exchange ions with electrolyte and electrons with an external circuit (a load or a charger).

There are two types of electrode reactions.
1. Cation based electrode reactions: In these reactions, the electrode captures or releases a cation Y⁺from electrolyte and an electron from the external circuit:

Electrode+Y⁺+e⁻→Electrode(Y).

Examples of cation based electrode reactions include: (i) carbon anode in a lithium ion battery: 6C+Li⁺+e⁻→LiC₆ (charge); (ii) lithium cobalt oxide cathode in a lithium ion battery: 2Li_{0.5}CoO₂+Li⁺+e⁻→2LiCoO₂ (discharge); (iii) Ni(OH)₂ cathode in rechargeable alkaline batteries: Ni(OH)₂→NiOOH+H⁺+e⁻ (charge); (iv) MnO₂ in saline Zn/MnO₂ primary batteries: MnO₂+H⁺+e⁻→HMnO₂ (discharge).
2. Anion based electrode reactions: In these reactions, the electrode captures or releases an anion X⁻ from electrolyte and an electron from the external circuit:

Electrode+X⁻→Electrode(X)+e⁻

Examples of anion based electrode reactions include: (i) Cadmium anode in the Nickel-Cadmium alkaline battery: Cd(OH)₂+2e⁻→Cd+2OH⁻ (charge); and (ii) Magnesium alloy anode in the magnesium primary batteries: Mg+2OH⁻→Mg(OH)₂+2e⁻ (discharge).

Many existing batteries are either of pure cation-type or mixed ion-type chemistries. Example of pure cation-type and mixed ion-type batteries are provided below:
1. Pure cation-type of battery: Lithium ion batteries are an example of pure cation-type chemistry. The electrode half reactions and cell reactions for lithium ion batteries are:

Carbon anode:

6C+Li⁺+e⁻→LiC₆ (charge)

lithium cobalt oxide cathode:

2Li_{0.5}CoO₂+Li⁺+e⁻→2LiCoO₂ (discharge)

cell reaction:

2LiCoO₂+6C→2Li_{0.5}CoO₂+LiC₆ (charge)

2Li_{0.5}CoO₂+LiC₆→2LiCoO₂+6C (discharge)
2. Mixed ion-type of battery: A Nickel/cadmium alkaline battery is an example of a mixed ion-type of battery. The electrode half reactions and cell reactions for a Nickel/cadmium alkaline battery are provided below:

Ni(OH)₂ cathode (cation-type):

Ni(OH)₂→NiOOH+H⁺+e⁻ (charge)

Cadmium anode (anion-type):

Cd(OH)₂→2e⁻→Cd+2OH⁻ (charge)

Cell reaction:

Cd(OH)₂+2Ni(OH)₂→Cd+2 NiOOH+2 H₂O (charge)

Cd+2 NiOOH+2 H₂O→Cd(OH)₂+2Ni(OH)₂ (discharge)

A Zn/MnO₂ battery is an example of a mixed ion-type of battery. The electrode half reactions and cell reactions for a Zn/MnO₂ battery are provided below:

Zn anode (anion-type):

Zn+2OH⁻→ZnO+H₂O+2e⁻ (discharge)

MnO₂ cathode (cation-type)

MnO₂+H⁺+e⁻→HMnO₂ (discharge)

Cell reaction:

Zn+2 MnO₂+H₂O→ZnO+2HMnO₂ (discharge)

As will be clear from the foregoing, there currently exists a need in the art for primary and secondary electrochemical cells for a range of important device application including the rapidly increasing demand for high performance portable electronics. Specifically, primary and secondary electrochemical cells are needed that are capable of providing useful cell voltages, specific capacities and cycle life, while at the same time exhibiting good stability and safety.

### SUMMARY OF THE INVENTION

The present invention provides electrochemical cells capable of good electrical power source performance, particularly high specific energies, useful discharge rate capabilities and good cycle life. Electrochemical cells of the present invention are versatile and include primary and secondary cells useful for a range of important applications including use in portable electronic devices.

In an aspect, the invention provides a battery comprising: a positive electrode comprising a carbon nanofiber or carbon nanotube material; a negative electrode comprising a graphite material; and an electrolyte provided between the positive electrode and the negative electrode; the electrolyte capable of conducting charge carriers between the positive electrode and the negative electrode; the electrolyte comprising a solvent and a fluoride salt, wherein the fluoride salt is at least partially present in a dissolved state in the electrolyte, thereby generating fluoride ions in the electrolyte; wherein the positive electrode and negative electrode exchange the fluoride ions with the electrolyte during charging or discharging of the battery.

In an embodiment, the positive electrode and negative electrode reversibly exchange fluoride ions with the electrolyte during charging and discharging of the battery. In an embodiment, for example, during discharge of the battery, fluoride ions are released from the positive electrode and accommodated by the negative electrode, and/or during charging of the battery fluoride ions are released from the negative electrode and accommodated by the positive electrode.

In some embodiments, batteries of the present invention have fluoride ions as anion charge carriers. In this context, anion charge carrier refers to a negatively charge ion provided in an electrolyte of an electrochemical cell that migrates between positive and negative electrodes during discharge and charging of the battery.

In some embodiments, the positive electrode, negative electrode or both are fluoride ion host materials capable of accommodating fluoride ions. In this context, accommodating includes insertion of fluoride ions into the host material, intercalation of fluoride ions into the host material and/or reaction of fluoride ions with the host material. In some embodiments, the positive electrode and negative electrode are different carbonaceous fluoride ion host materials, for example, the positive electrode comprising a multiwalled nanotube or multiwalled carbon fiber material and the negative electrode comprising graphite.

In an embodiment, the positive electrode comprises a carbon nanofiber material, such as a multiwalled carbon nanofiber material. In an embodiment, the positive electrode comprises a carbon nanotube material, such as a multiwalled carbon nanotube material. In an embodiment, the positive electrode comprises an irradiated material, such as an irradiated carbon nanofiber powder. In an embodiment, the positive electrode further comprises a polyvinylidene fluoride component, for example, a mixture wherein the ratio of the masses of the carbon nanofiber or carbon nanotube material to the polyvinylidene fluoride component is selected over the range of 2 to 4.

In an embodiment, the positive electrode is electrochemically precycled prior to use in the battery. In an embodiment, for example, the positive electrode is electrochemically precycled with fluoride ions prior to being provided in the battery, wherein fluoride ions are electrochemically inserted into and removed from the positive electrode during precycling. In an embodiment, the positive electrode is provided in the battery in a substantially defluorinated state.

In an embodiment, negative electrode is a graphite electrode, such as a MCMB graphite electrode. In an embodiment, the negative electrode further comprises a conductive carbon component, such as an ABC material. In an embodiment, the negative electrode is electrochemically precycled prior to use in the battery. In an embodiment, for example, the negative electrode is precycled with lithium ions prior to being provided in the battery, wherein lithium ions are electrochemically inserted into and removed from the negative electrode during precycling. In an embodiment, the negative electrode is provided in a substantially delithiated state.

Fluoride ions in some embodiments are generated by at least partial dissolution of a fluoride ion salt of the electrolyte. In an embodiment, the fluoride salt of the electrolyte is a lithium fluoride salt, such as LiPF₆^{.} The invention also includes embodiments having other lithium salts including, but not limited to, electrolytes having a lithium salt selected from the group consisting of: LiBF₄, LiAsF₆, LiBiF₆ and LiSF₇. Useful solvents for some embodiments include nonaqueous solvents, such as polar nonaqeuous solvents. In an embodiment, for example, the solvent is ethylene carbonate, dimethyl carbonate or a combination of ethylene carbonate and dimethyl carbonate. In an embodiment, for example, the electrolyte is 1M LiPF6 in ethylene carbonate/dimethyl carbonate (EC/DMC) (+0.1 M KF).

The following references describe electrolyte compositions that may be useful in some specific embodiments of the present invention, including fully fluorinated and partially fluorinated solvents, salts and anion charge carriers, and are hereby incorporated by reference in their entireties to the extent not inconsistent with the present disclosure: (1) Li[C₂F₅BF₃] as an Electrolyte Salt for 4 V Class Lithium-Ion Cells, Zhi-Bin Zhou, Masayuki takeda, Takashi Fujii, Makoto Ue, Journal of Electrochemical Society, 152(2):A351-A356, 2005; (2) Fluorinated Superacidic Systems, George A. Olah, Surya G. K. Prakash, Alain Goeppert, Actualite Chimique, 68-72 Suppl. 301-302, October-November 2006; (3) Electrochemical properties of Li[CₙF₂ₙ₊₁BF₃] as Electrolyte Salts for Lithium-ion Cells, Makoto Ue, Takashi Fujii, Zhi-Bin Zhou, Masayuki Takeda, Shinichi Kinoshita, Solid State Ionics, 177:323-331, 2006; (4) Anodic Stability of Several Anions Examined by AB Initio Molecular Orbital and Density Functional Theories, Makoto Ue, Akinori Murakami, Shinichiro Nakamura, Journal of Electrochemical Society, 149(12):A1572-A1577, 2002; (5) Intrinsic Anion Oxidation Potentials, Patrik Johansson, Journal of Physical Chemistry, 110_{—}12077-12080, 2006; (6) Nonaqueous Liquid Electrolytes for Lithium-based Rechargeable Batteries, Kang Xu, Chem. Rev., 104:4303-4417, 2004; (7) The Electrochemical Oxidation of Polyfluorophenyltrifluoroborate Anions in Acetonitrile, Leonid A. Shundrin, Vadim V. Bardin, Hermann-Josef Frohn, Z. Anorg. Allg. Chem. 630:1253-1257, 2004.

Useful solvents for electrolytes of the present invention are capable of at least partially dissolving electrolyte salts, such as fluoride salts, and include, but are not limited to one or more solvent selected from the group consisting of propylene carbonate, nitromethane, Toluene (tol); ethylmethyl carbonate (EMC); Propylmethyl carbonate (PMC); Diethyl carbonate (DEC); Dimethyl carbonate (DMC); Methyl butyrate (MB, 20° C.); n-Propyl acetate (PA); Ethyl acetate (EA); Methyl propionate (MP); Methyl acetate (MA); 4-Methyl-1,3-dioxolane (4MeDOL)(C₄H₈O₂); 2-Methyltetrahydrofuran (2MeTHF)(C₅H₁₀O); 1,2 Dimethoxyethane (DME); Methyl formate (MF)(C₂H₄O₂); Dichloromethane (DCM); γ-Butyrolactone (γ-BL)(C₄H₆O₂); Propylene carbonate (PC)(C₄H₆O₃); Ethylene carbonate (EC, 40° C.)(C₃H₄O₃). Electrolytes, and components thereof, comprising full or partially fluorinated analogs of solvents, electrolyte salts and anion charge carriers are beneficial for some applications because fluorination of these materials imparts enhanced stability with respect to decomposition at high electrode voltages and provides beneficial safety characteristics, such as flame retardance. In the context of this description, fluorine analogs include: (i) fully fluorinated analogs wherein each hydrogen atom of the solvent, salt or anion charge carrier molecule is replaced by a fluorine atom, and (ii) partially fluorinated analogs wherein at least one hydrogen atom of the solvent, salt or anion charge carrier molecule is replaced by a fluorine atom.

Batteries of the invention include primary electrochemical cells and secondary electrochemical cells.

Without wishing to be bound by any particular theory, there can be discussion herein of beliefs or understandings of underlying principles or mechanisms relating to the invention. It is recognized that regardless of the ultimate correctness of any explanation or hypothesis, an embodiment of the invention can nonetheless be operative and useful.

### BRIEF DESCRIPTION OF THE DRAWINGS

FIG. 1. FIG. 1 provides a schematic of the electrochemical cell used for evaluating cycling including: (1) the carbon nanofiber film (serving as the cathode) in electrical contact with aluminum foil; (2) a glass fiber membrane soaked with electrolyte and (3) a lithium anode.

FIG. 2. Provides plots of Current (A) (left) and Voltage (V) (right) verses Test Time (h) for cycling of a cathode half cell comprising: (1) an irradiated carbon nanotube material (75% wt %) and a polyvinylidene fluoride (PVDF) component (25% wt %) (m_{eletrode}=7.4 mg). The electrolyte is 1M LiPF₆ in ethylene carbonate/dimethyl carbonate (EC/DMC)+0.5% VEC. Results for discharge rates of C/6 and C/3 are provided.

FIG. 3. Provides plots of current (A) (left) and Voltage (V) (right) verses Test Time (h) for cycling of a cathode half cell comprising: (1) an irradiated carbon nanotube material (75% wt %) and a polyvinylidene fluoride (PVDF) component (25% wt %) (m_{eletrode}=7.4 mg). The electrolyte is 1M LiPF₆ in ethylene carbonate/dimethyl carbonate (EC/DMC)+0.5% VEC. Results for charge and discharge for 5^{th} and 6^{th} cycles are provided. The discharge rate is C/3.

FIG. 4. Provides plots of Capacity (mAh/g) (left) and Efficiency (right) verses Cycle No. for a cathode half cell comprising: (1) an irradiated carbon nanotube material (75% wt %) and a polyvinylidene fluoride (PVDF) component (25% wt %) (m_{eletrode}=7.4 mg). The electrolyte is 1M LiPF₆ in ethylene carbonate/dimethyl carbonate (EC/DMC)+0.5% VEC. Charge capacities, discharge capacities and efficiencies are provided.

FIG. 5. Provides plots corresponding to a graphite anode pre-cycling at a discharge rate of C/5. Examples of fully lithiated and fully delithiated states are indicated in the plots.

FIG. 6. FIG. 6 provides a schematic of a lithium ion fluoride full cell having: (1) a cycled multiwalled nanotube cathode in contact with an aluminum foil glued on the can; (2) 2 thick glass fiber separators; and (3) a cycled graphite anode (on copper substrate) glued on to the can. Also provided is a schematic showing that the half cell is opened in the glove box to get the minus side of the can.

FIG. 7. FIG. 7 provides plots showing the lithium ion fluoride battery cycle profile (0.1 M KF in electrolyte). In FIG. 7, electric potential E(v) is plotted verses time (hours).

FIG. 8. FIG. 8 provides a plot showing the second cycle for the lithium ion fluoride full cell. In FIG. 8, electric potential E(v) is plotted verses time (hours).

FIG. 9. FIG. 9 provides a plot showing the twenty fourth cycle for the lithium ion fluoride full cell. In FIG. 9, electric potential E(v) is plotted verses time (hours).

FIG. 10. FIG. 10 provides plots of charge and discharge capacities versus the number of cycles for the lithium ion fluoride full cell. In FIG. 10, Capacity (mAh) is plotted verse cycle index. Results for charge capacity and discharge capacity are shown.

FIG. 11. FIG. 11 provides plots for the uncycled anode—0.1 M KF in Electrolyte. In FIG. 11, electric potential E(v) is plotted verses time (hours).

FIG. 12. FIG. 12 provides plots for the uncycled anode—0.1 M KF in Electrolyte 1^{st} discharge. In FIG. 12, electric potential E(v) is plotted verses time (hours). A discharge capacity equal to 0.66 mAh is indicated.

FIG. 13. FIG. 13 provides plots for the cycled anode—No KF in Electrolyte. In FIG. 13, electric potential E(v) is plotted verses time (hours). A cathode capacity equal to 0.81 mAh is indicated. A first discharge capacity of 0.19 mAh and a second discharge capacity of 0.14 mAh are indicated.

FIG. 14. FIG. 14 provides plots for the cycled anode—No KF in Electrolyte for the 2^{nd} discharge. In FIG. 14, electric potential E(v) is plotted verses time (hours).

### DETAILED DESCRIPTION OF THE INVENTION

Electrode refers to an electrical conductor where ions and electrons are exchanged with electrolyte and an outer circuit. “Positive electrode” and “cathode” are used synonymously in the present description and refer to the electrode having the higher electrode potential in an electrochemical cell (i.e. higher than the negative electrode). “Negative electrode” and “anode” are used synonymously in the present description and refer to the electrode having the lower electrode potential in an electrochemical cell (i.e. lower than the positive electrode). Cathodic reduction refers to a gain of electron(s) of a chemical species, and anodic oxidation refers to the loss of electron(s) of a chemical species. Positive electrodes and negative electrodes of the present electrochemical cell may further comprises a conductive diluent, such as acetylene black, carbon black, powdered graphite, coke, carbon fiber, and metallic powder, and/or may further comprises a binder, such polymer binder. The positive electrode and negative electrode may also comprise a current collector, as known in the art. Useful binders for positive electrodes in some embodiments comprise a fluoropolymer such as polyvinylidene fluoride (PVDF). Positive and negative electrodes of the present invention may be provided in a range of useful configurations and form factors as known in the art of electrochemistry and battery science, including thin electrode designs, such as thin film electrode configurations. Electrodes are manufactured as disclosed herein and as known in the art, including as disclosed in, for example, U.S. Pat. Nos. 4,052,539, 6,306,540, 6,852,446. For some embodiments, the electrode is typically fabricated by depositing a slurry of the electrode material, an electrically conductive inert material, the binder, and a liquid carrier on the electrode current collector, and then evaporating the carrier to leave a coherent mass in electrical contact with the current collector.

The term “electrochemical cell” refers to devices and/or device components that convert chemical energy into electrical energy or electrical energy into chemical energy. Electrochemical cells have two or more electrodes (e.g., positive and negative electrodes) and an electrolyte, wherein electrode reactions occurring at the electrode surfaces result in charge transfer processes. Electrochemical cells include, but are not limited to, primary batteries, secondary batteries and electrolysis systems. General cell and/or battery construction is known in the art, see e.g., U.S. Pat. Nos. 6,489,055, 4,052,539, 6,306,540, Seel and Dahn J. Electrochem. Soc. 147(3) 892-898 (2000).

“Electrode potential” refers to a voltage, usually measured against a reference electrode, due to the presence within or in contact with the electrode of chemical species at different oxidation (valence) states.

“Electrolyte” refers to an ionic conductor which can be in the solid state, the liquid state (most common) or more rarely a gas (e.g., plasma).

“Cation” refers to a positively charged ion, and “anion” refers to a negatively charged ion.

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrochemical cell, such as a battery, per unit weight. Specific capacity is typically expressed in units of ampere-hours kg⁻¹.

The term “discharge rate” refers to the current at which an electrochemical cell is discharged. Discharge current can be expressed in units of amperes. Alternatively, discharge current can be normalized to the rated capacity of the electrochemical cell, and expressed as C/(X t), wherein C is the capacity of the electrochemical cell, X is a variable and t is a specified unit of time, as used herein, equal to 1 hour.

“Current density” refers to the current flowing per unit electrode area.

The present invention provides primary and secondary anionic electrochemical cells, such as batteries, utilizing fluoride ion charge carriers and active electrode materials comprising fluoride ion host materials, such as carbonaceous materials, that provide an alternative to conventional state of the art lithium batteries and lithium ion batteries.

Aspects of the present invention are further set forth and described in the following Examples, which are offered by way of illustration of specific embodiments and are not intended to limit the scope of the invention in any manner.

### Example 1

### Lithium Ion Fluoride Battery

Two half cells were prepared having the following positive and negative electrodes: 1) with MWNT cathode, and b) with MCMB (graphite) anode. The half cells were individually cycled several times. In these experiments, the last step of the cycling being a full discharge for the cathode (de-fluorination) and full charge for the anode (de-lithiation). This process served to electrochemically precycle the cathode and anode prior to integration into a full cell configuration. The electrodes were then assembled in a full lithium ion fluoride battery and cycled several times.

### Cathode Preparation for Lithium Ion Fluoride Battery

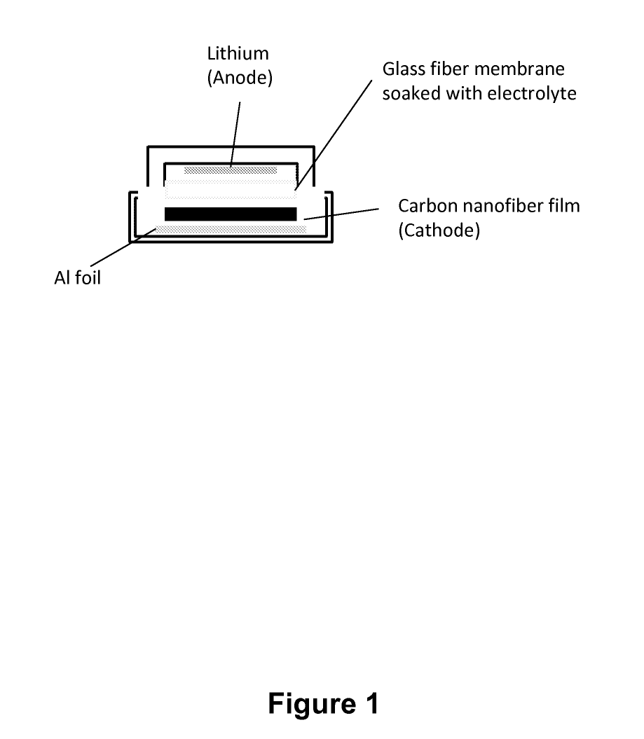

The composition of the cathode was a film of Irradiated Carbon nanofiber powder (75% in wt.)+PVDF (25%). FIG. 1 provides a schematic of the electrochemical cell used for cycling including: (1) the carbon nanofiber film (serving as the cathode in electrical contact with aluminum foil; (2) a glass fiber membrane soaked with electrolyte and (3) a lithium anode. The half cell of the cathode is: Cathode Cycling Half cell: Li/1M LiPF6 in EC/DMC+0.5% VEC/C.

The half cell was cycled over many cycles, and discharged to 3. After cycling to a discharge state the cell opened in a glove box and the cathode film was washed in DMC and dried under vacuum.

FIG. 1 provides a schematic of the electrochemical cell used for evaluating cycling including: (1) the carbon nanofiber film (serving as the cathode) in contact with aluminum foil; (2) a glass fiber membrane soaked with electrolyte and (3) a lithium anode.

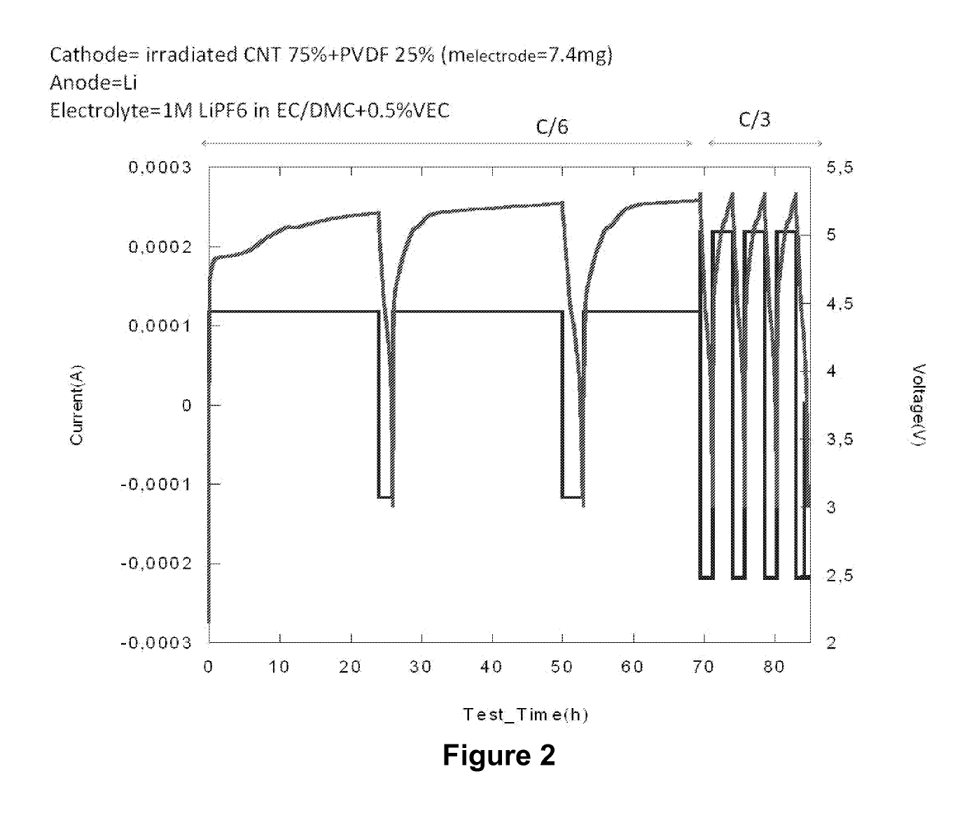

FIG. 2 provides plots of Current (A) (left) and Voltage (V) (right) verses Test Time (h) for cycling of a cathode half cell comprising: (1) an irradiated carbon nanotube material (75% wt %) and a polyvinylidene fluoride (PVDF) component (25% wt %) (m_{eletrode}=7.4 mg). The electrolyte is 1M LiPF₆ in ethylene carbonate/dimethyl carbonate (EC/DMC) +0.5% VEC. Results for discharge rates of C/6 and C/3 are provided.

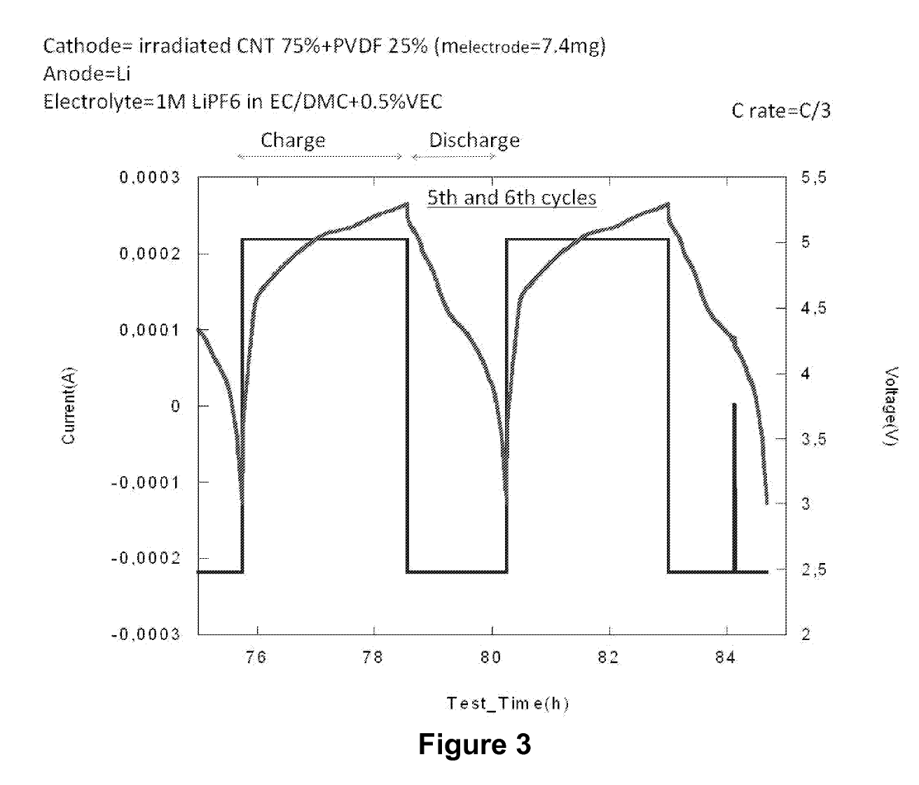

FIG. 3 provides plots of current (A) (left) and Voltage (V) (right) verses Test Time (h) for cycling of a cathode half cell comprising: (1) an irradiated carbon nanotube material (75% wt %) and a polyvinylidene fluoride (PVDF) component (25% wt %) (m_{eletrode}=7.4 mg). The electrolyte is 1M LiPF₆ in ethylene carbonate/dimethyl carbonate (EC/DMC)+0.5% VEC. Results for charge and discharge for 5^{th} and 6^{th} cycles are provided. The discharge rate is C/3.

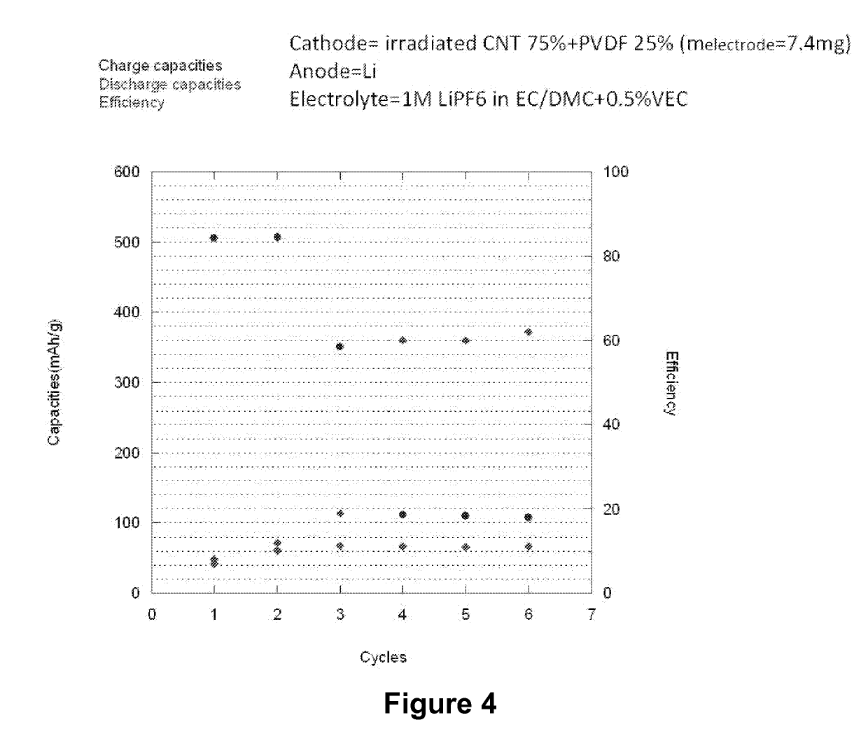

FIG. 4 provides plots of Capacity (mAh/g) (left) and Efficiency (right) verses Cycle No. for a cathode half cell comprising: (1) an irradiated carbon nanotube material (75% wt %) and a polyvinylidene fluoride (PVDF) component (25% wt %) (m_{eletrode}=7.4 mg). The electrolyte is 1M LiPF₆ in ethylene carbonate/dimethyl carbonate (EC/DMC)+0.5% VEC. Charge capacities, discharge capacities and efficiencies are provided.

### Graphite Anode Preparation

Conductive glue preparation (Torr Seal+ABG) was achieved by the following process. About 1 cm of the resin is dissolved in ≈10 mL acetone and 120 mg of conductive carbon (ABG) is mixed with the dissolved resin. Then acetone is evaporated (until it becomes very viscous). About 1 cm of the hardener is mixed to the resin—ABG mix. Then a drop of the glue is then put on coin cell can. Then the electrode is glued on the—can of the coin cell.

The anode was pre-cycled in a half cell configuration. For example, the anode is cycled 4 times with lithium metal and 1 M LiPF6 in EC/DMC. The experiment is stopped in the fully lithiated state (at 0.001 V) for a charged state full cell or in the fully delithiated state (at 1.5 V) for a discharged state full cell.

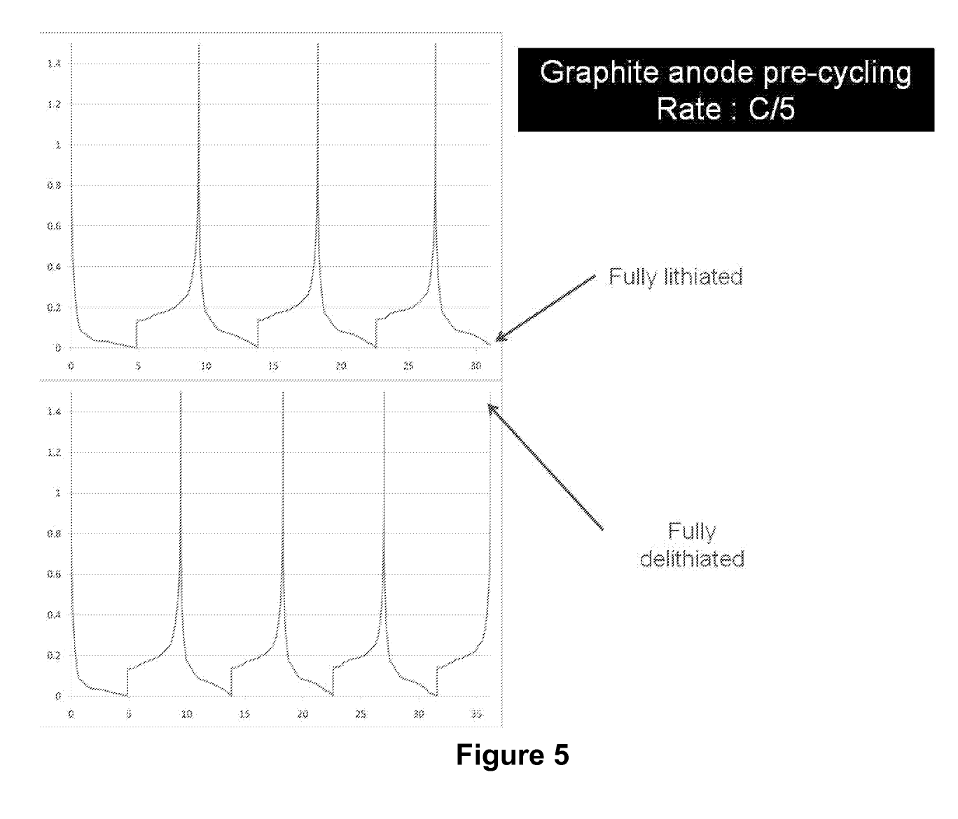

FIG. 5 provides plots corresponding to a graphite anode pre-cycling at a discharge rate of C/5. Examples of fully lithiated and fully delithiated states are indicated in the plots.

### Lithium Ion Fluoride Full Cell

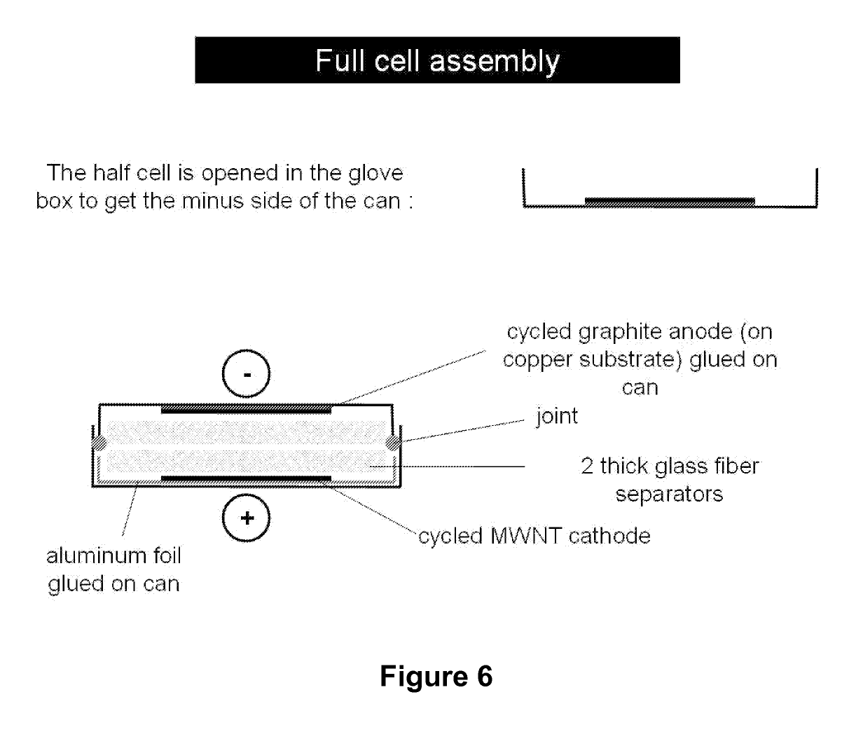

FIG. 6 provides a schematic of a lithium ion fluoride full cell having: (1) a cycled multiwalled nanotube cathode in contact with an aluminum foil glued on the can;

(2) 2 thick glass fiber separators; and (3) a cycled graphite anode (on copper substrate) glued on to the can. Also provided is a schematic showing that the half cell is opened in the glove box to get the minus side of the can.

A summary of the materials and half reactions for the full cell experiments are provided below.

### Electrode Composition

Cathode: pre-cycled MWNT fully defluorinated
Anode: pre-cycled graphite fully delithiated

### Half Reactions (During Charge)

Anode: 6C+Li⁺+e⁻→LiC₆
Cathode: C+xF⁻→CFₓ+xe⁻

### Electrolyte Composition

electrolyte: 1 M LiPF₆ in EC/DMC (+0.1 M KF)

In some experiments, the battery is cathode limited (≈0.6 mAh against 3.5 mAh for the anode). The open current voltage (OCV) after assembly is ≈3 V. The full cell cycled between 2 V and 5.2 V (or up to 5.4 V) at C/5 rate.

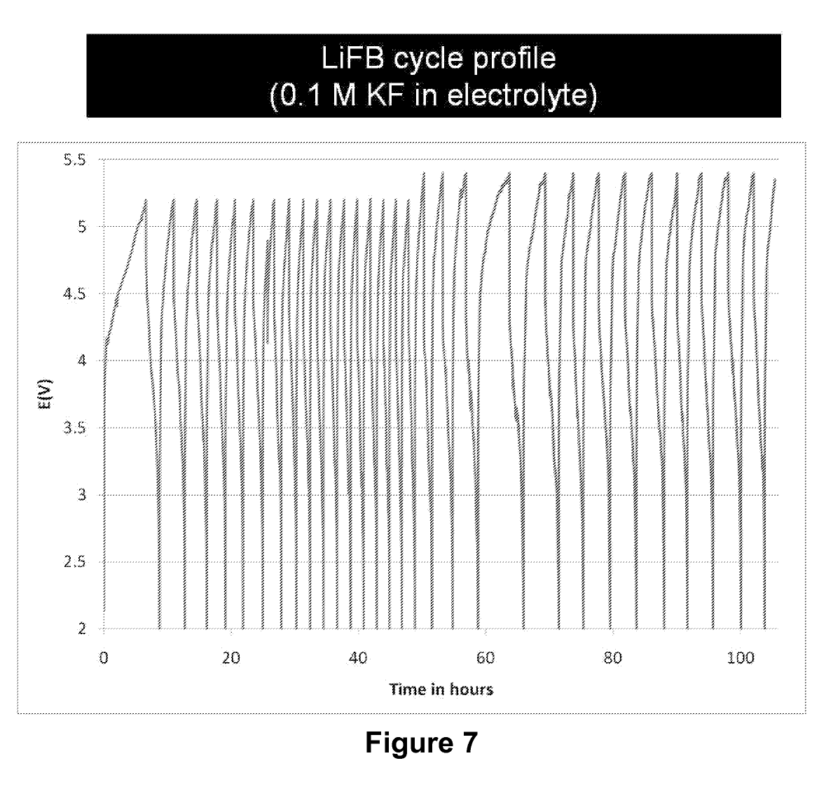

FIG. 7 provides plots showing the lithium ion fluoride battery cycle profile (0.1M KF in electrolyte). In FIG. 7, electric potential E(v) is plotted verses time (hours).

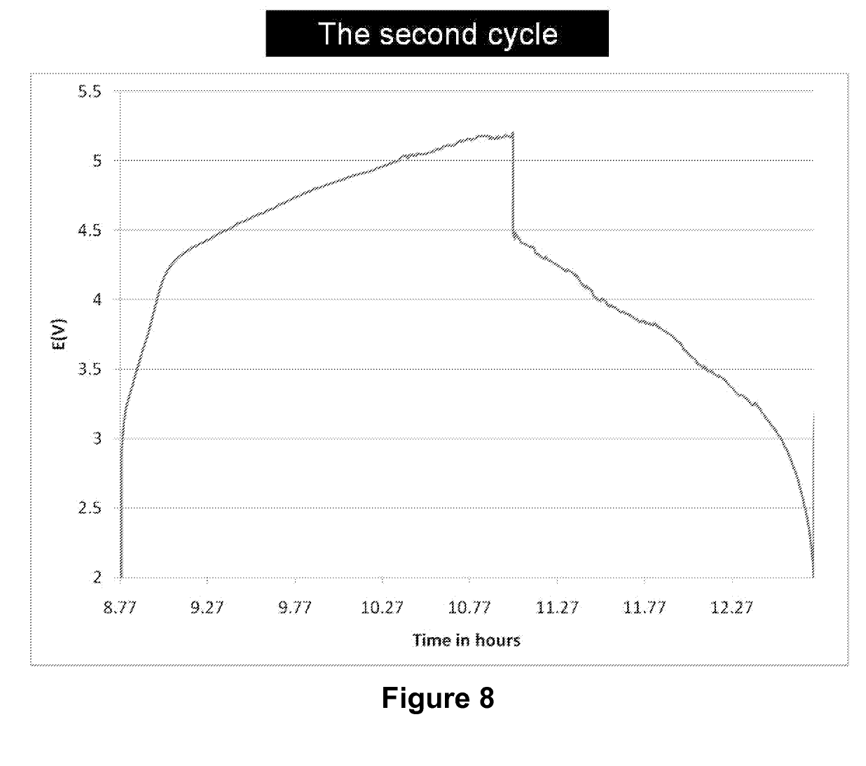

FIG. 8 provides a plot showing the second cycle for the lithium ion fluoride full cell. In FIG. 8, electric potential E(v) is plotted verses time (hours).

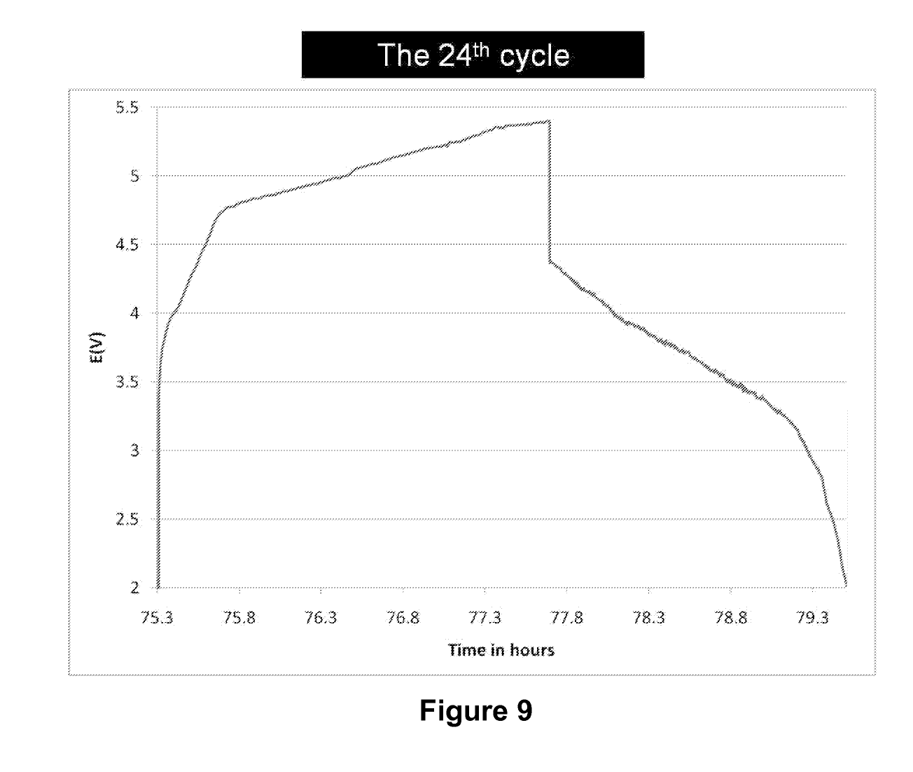

FIG. 9 provides a plot showing the twenty fourth cycle for the lithium ion fluoride full cell. In FIG. 9, electric potential E(v) is plotted verses time (hours).

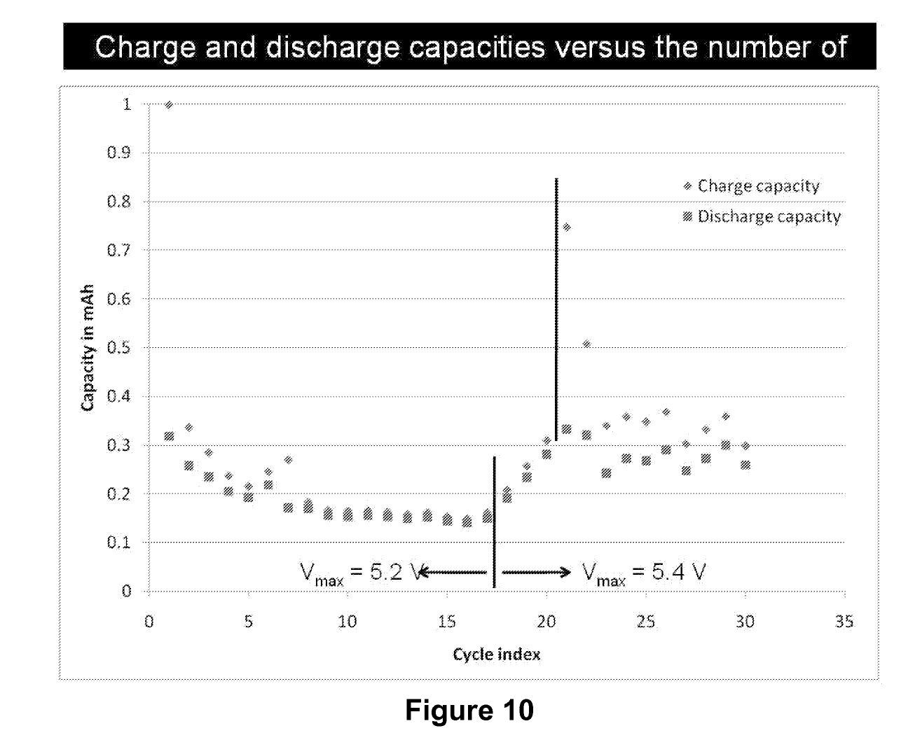

FIG. 10 provides plots of charge and discharge capacities versus the number of cycles for the lithium ion fluoride full cell. In FIG. 10, Capacity (mAh) is plotted verse cycle index. Results for charge capacity and discharge capacity are shown.

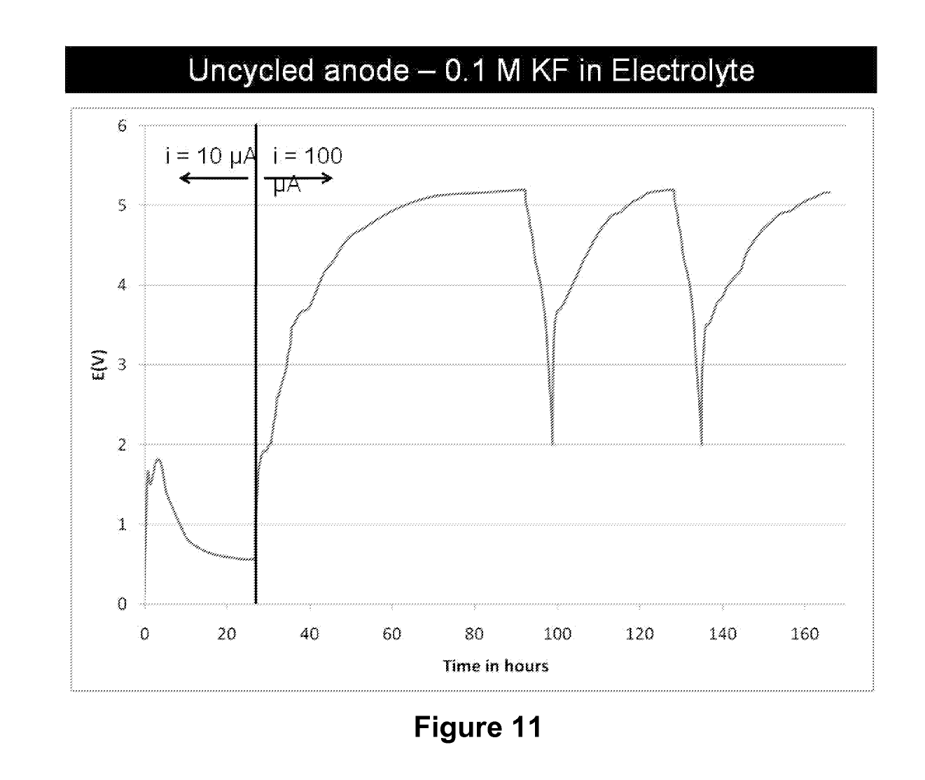

FIG. 11 provides plots for the uncycled anode—0.1 M KF in Electrolyte. In FIG. 11, electric potential E(v) is plotted verses time (hours).

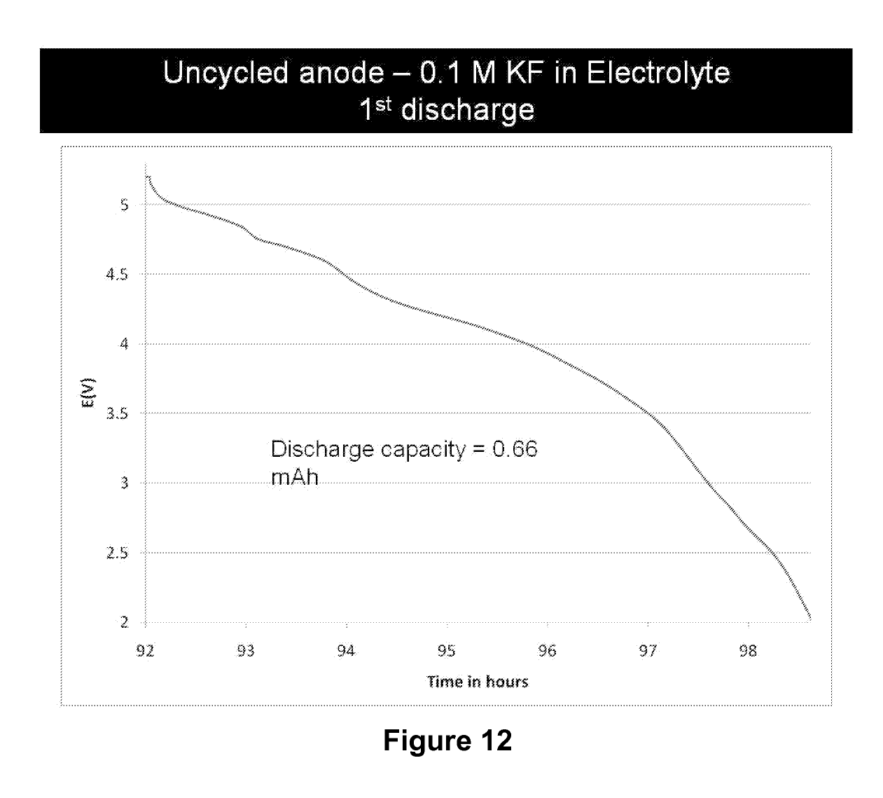

FIG. 12 provides plots for the uncycled anode—0.1 M KF in Electrolyte 1^{st} discharge. In FIG. 12, electric potential E(v) is plotted verses time (hours). A discharge capacity equal to 0.66 mAh is indicated.

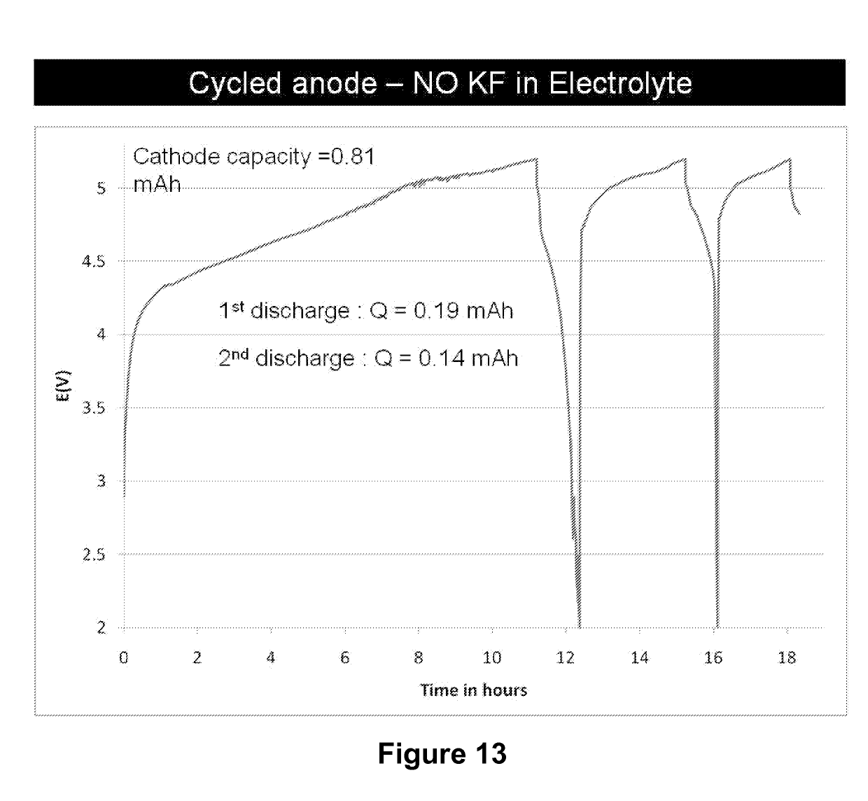

FIG. 13 provides plots for the cycled anode—No KF in Electrolyte. In FIG. 13, electric potential E(v) is plotted verses time (hours). A cathode capacity equal to 0.81 mAh is indicated. A first discharge capacity of 0.19 mAh and a second discharge capacity of 0.14 mAh are indicated.

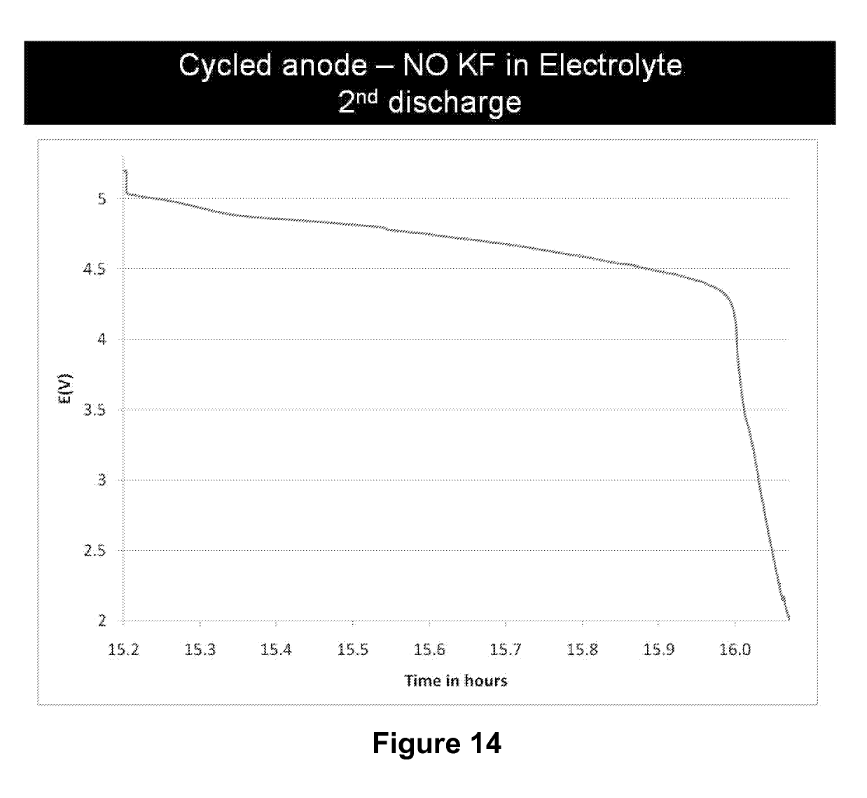

FIG. 14 provides plots for the cycled anode—No KF in Electrolyte for the 2^{nd} discharge. In FIG. 14, electric potential E(v) is plotted verses time (hours).

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Many of the molecules disclosed herein contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A battery comprising:
a positive electrode comprising a carbon nanofiber or carbon nanotube material;
a negative electrode comprising a graphite material; and
an electrolyte provided between said positive electrode and said negative electrode; said electrolyte capable of conducting charge carriers between said positive electrode and said negative electrode; said electrolyte comprising a solvent and a fluoride salt, wherein said fluoride salt is at least partially present in a dissolved state in said electrolyte, thereby generating fluoride ions in said electrolyte;
wherein said positive electrode and negative electrode exchange said fluoride ions with said electrolyte during charging or discharging of said battery.

2. The battery of claim 1, wherein said positive electrode and negative electrode reversibly exchange said fluoride ions with said electrolyte during charging and discharging of said battery.

3. The battery of claim 1, wherein said positive electrode comprises a multiwalled carbon nanofiber material.

4. The battery of claim 1, wherein said positive electrode comprises a multiwalled carbon nanotube material.

5. The battery of claim 1, wherein said positive electrode comprises an irradiated material.

6. The battery of claim 1, wherein said positive electrode further comprises a polyvinylidene fluoride component.

7. The battery of claim 1, wherein said positive electrode comprises a mixture of the carbon nanofiber or nanotube material and a polyvinylidene fluoride component.

8. The battery of claim 6, wherein the ratio of the masses of said carbon nanofiber or carbon nanotube material to said polyvinylidene fluoride component is selected over the range of 2 to 4.

9. The battery of claim 1, wherein said positive electrode is electrochemically precycled with fluoride ions prior to being provided in said battery, wherein said fluoride ions are electrochemically inserted into and removed from said positive electrode during precycling.

10. The battery of claim 1, wherein said positive electrode is provided in a substantially defluorinated state.

11. The battery of claim 1, wherein said negative electrode is a graphite electrode.

12. The battery of claim 1, wherein said negative electrode is electrochemically precycled with lithium ions prior to being provided in said battery, wherein said lithium ions are electrochemically inserted into and removed from said negative electrode during precycling.

13. The battery of claim 1, wherein said negative electrode is provided in a substantially delithiated state.

14. The battery of claim 1, wherein said negative electrode further comprises conductive carbon component.

15. The battery of claim 1, wherein said fluoride salt is LiPF₆.

16. The battery of claim 1, wherein said solvent is ethylene carbonate, dimethyl carbonate or a combination of ethylene carbonate and dimethyl carbonate.

17. The battery of claim 1, wherein said electrolyte is 1M LiPF₆ in ethylene carbonate/dimethyl carbonate (+0.1 M KF).

18. The electrochemical cell of claim 1, wherein during discharge of said battery, said fluoride ions are released from said positive electrode and accommodated by said negative electrode, and wherein during charging of said battery, said fluoride ions are released from said negative electrode and accommodated by said positive electrode.

19. The battery of claim 1 comprising a secondary electrochemical cell.

20. A method for generating an electrical current, said method comprising the steps of:
providing a battery; said battery comprising:
a positive electrode comprising a carbon nanofiber or carbon nanotube material;
a negative electrode comprising a graphite material; and
an electrolyte provided between said positive electrode and said negative electrode; said electrolyte capable of conducting charge carriers between said positive electrode and said negative electrode; said electrolyte comprising a solvent and a fluoride salt, wherein said fluoride salt is at least partially present in a dissolved state in said electrolyte, thereby generating fluoride ions in said electrolyte;
discharging said electrochemical cell, wherein during discharge of said battery, said fluoride ions are released from said positive electrode and accommodated by said negative electrode.
